(19) United States
(12) Patent Application Publication
(10) Pub. No.: US 2018/0352829 A1
(43) Pub. Date: Dec. 13, 2018

(54) AMUSEMENT APPARATUS PROVIDED WITH AN EDIBLE PORTION AND METHODS

(71) Applicant: Imaginings 3, Inc., Niles, IL (US)

(72) Inventors: Sidney Diamond, Barrington Hills, IL (US); David Lisowski, Schaumburg, IL (US)

(21) Appl. No.: 16/001,433

(22) Filed: Jun. 6, 2018

Related U.S. Application Data
(60) Provisional application No. 62/517,506, filed on Jun. 9, 2017.

(51) Int. Cl. A23G 3/56; A63H 33/00; A63H 29/08; A44C 9/00

(52) U.S. Cl. CPC A23G 3/563; A44C 9/00; A63H 29/08; A63H 33/00

(57) ABSTRACT

A combination finger ring, movable spinning object and a hard candy fixed in position by an exterior post. The finger ring may include a novelty ring housing. The exterior post extends from the finger ring and supports the movable spinning object at the exterior post between the affixed hard candy and the finger ring. The exterior post may include an axle portion supporting the movable spinning object. The movable spinning object may include a circular rotary object propelled into motion by the flick of a finger or by blowing on the movable spinning object which is freely movable and spins relative to the finger ring. The movable spinning object may include a round disk, the surface of which may include a printed design, label or sticker with colors or patterns on the round disk. A rainbow swirl image or the like may be generated while spinning the disk for further amusement.

### PRIORITY CROSS-REFERENCE TO RELATED APPLICATION

This application claims priority pursuant to 35 U.S.C. 119(e) or 120 from U.S. Provisional Application No. 62/517,506 filed Jun. 9, 2017 for inventions disclosed therein incorporated by reference.

### FIELD OF THE INVENTION

The inventions pertain to the field of amusement with entertaining spinning devices equipped with a ring toy and a candy. More particularly, the invention pertains to novel amusing apparatus to be worn as a ring with a candy of a variety of different shapes and forms attached to the top of the toy for consumption. The amusing toy also has a spinning portion between the candy and the ring.

### BACKGROUND OF THE INVENTION

There are several varieties of toys candies on the market. Most commonly lollipop and ball shape candies are provided with a straight soft plastic or paper stick, tube or rod. Those candies on a straight stick are exposed to a danger of sucked into mouth of the user, especially younger users, and choke the throat. It is known this type of toy candies present particular danger when the user is an infant of age under two.

U.S. Pat. No. 5,591,062 to Hettinger for “Spinning Toy” discloses a toy comprising a center dome structure and a skirt used as a spinning toy. The Hettinger toy is designed to be spun on the finger to provide a simple diversion for children and adults. The device is also disclosed to provide a means to stop smoking by giving the users something to do with their hands.

A similar spinning toy is the subject of U.S. Pat. No. 9,914,063 to McCoskery for “Toy Designed to Spin in a User's Hand.” The McCoskery '063 Patent discloses a spinner that comprises a body with a centrally mounted ball bearing positioned within a center orifice of the body, wherein an outer race of the ball bearing is attached to the frame; a button made of a pair of bearing caps attached to one another through the ball bearing, such that when the button is held between a user's thumb and finger, the body freely rotates about the ball bearing; and a plurality of weights distributed at opposite ends of the body, creating at least bipolar weight distribution.

U.S. Patent Application Publication No. US 2008/0248170 A1 to Lee for “Re-usable Toy Candy Stick with a Holding Ring and A Cross Guard Plate” discloses a toy candy stick comprises a holding ring and a cross-guard plate. A stick candy is engaged to the center of a face of the cross-guard plate. The cross-guard plate prevents the candy from sucked into user's mouth and chuck the user's neck by accident. The holding ring provides a more solid grip of the candy.

U.S. Patent Application Publication No. US 2005/0153621 A1 to Gillmour-Bryant, et al. for Lighted ring toy with consumable portion illustrates a luminous candy ring comprises a housing containing a power source and an electrical circuit, the housing having an upwardly extending portion for supporting a consumable portion; a finger-grasping portion extending from the housing for engagement with the finger of a user; and an illuminating element connectable to the electrical circuit and the power source to illuminate the consumable portion.

None of the prior art illustrates a candy novelty ring that combining hard candy and a spinner with a ring to be worn on a user's finger with mechanical amusement structures. Various toy candies include a holding ring for safer candy consumption while some candy rings have lights in the candy but offer limited amusement value. However, none of these toys allow the user to wear the toy on their finger like a ring while the consumable is on top of a spinner. The invention relates to the provision of an edible candy toy in the form of a finger ring. A non-edible spinning object, or other rotating object (e.g. Pinwheels, Flowers, Propellers, Patterned Disks, Spinners and the like) is combined in a fixed relative position by extending from a candy novelty ring.

### SUMMARY OF THE INVENTION

A relevant object of the present inventions provides a novelty ring that is more safe for the user while minimizing contamination of environment with disposed candy stick of prior art. The novel apparatus and methods are simple yet easy to use and provides pleasure to children, as well as user engagement and stress relief with mechanical amusement structures. A novel combination finger ring, movable spinning object and a hard candy fixed in position by an exterior post. The finger ring may include a novelty ring housing. The exterior post extends from the finger ring and supports the movable spinning object at the exterior post between the affixed hard candy and the finger ring. The exterior post may include an axle portion supporting the movable spinning object. The movable spinning object may include a circular rotary object such as a multi-end hub-and-spoke shaped rotary object such as a Fidget™ propelled into motion by the flick of a finger or by blowing on the movable spinning object which is freely movable and spins relative to the finger ring. The movable spinning object may include a round disk, the surface of which may include a printed design or label, or sticker with colors or patterns on the round disk which may generate a rainbow swirl image or the like, and accordingly while spinning the generated image on the disk creates further amusement for the user while consuming the hard candy. The exterior post and the axle may be provided as integral with the novelty ring housing of the finger ring.

Briefly summarized an amusement apparatus is provided including a finger ring, an exterior post extending from the finger ring, and an edible portion affixed in position on the exterior post. An amusement object includes a non-edible portion disposed at the exterior post supporting the object between the affixed edible portion and the finger ring with the object further disposed as moveable in relation to the finger ring and moveable in relation to the exterior post extending therefrom.

### BRIEF DESCRIPTION OF THE DRAWINGS

The patent or application file contains at least one drawing executed in color or grayscale. Copies of this patent or patent application publication with color or grayscale drawing will be provided by the Office upon request and payment of the necessary fee. For the purpose of facilitating an understanding of the invention, the accompanying drawings and detailed description illustrate a preferred embodiment thereof, from which the invention, its structures, its constructions and operations, its processes, and many related advantages may be readily understood and appreciated.

FIG. 1 is a perspective views of novelty hard candy finger ring items known in the prior art;

FIG. 2 is a perspective view of the a toy with hard candy in the form of a finger ring of the present inventions, and FIG. 3 is a bottom plan view thereof;

FIGS. 4 and 5A show exploded views of the toy with hard candy in the form of a finger ring combinations of the instant inventions;

FIGS. 5B-5F illustrates component views of an alternate embodiment inner bearings disk and outer disk assembly combination for movable spinning toy amusement objects in accordance with the instant inventions;

FIG. 6 is an partial view thereof for the toy in the form of a finger ring plastic ring showing a toy spinner and an injection molded candy base post of the instant inventions with hard candy removed for illustrative purposes;

FIGS. 7, 8, 9, 10 and 11 illustrate various different embodiments for the spinner component of the instant inventions which may be used with the finger ring and the injection molded candy base with post as disclosed;

FIG. 12 show exploded views of yet another embodiment of the toy with hard candy in the form of a finger ring combinations, with FIG. 13 showing the assembled embodiment ready to amuse the user with hard candy and spinner of the instant inventions;

FIGS. 14A-14D illustrate another embodiment of the instant inventions; and

FIG. 15 illustrates another embodiment of the for the spinner component of the instant inventions.

### DETAILED DESCRIPTION OF THE EMBODIMENTS

The following description is provided to enable those skilled in the art to make and use the described embodiments set forth in the best mode contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention. Likewise, a reasonably broad scope for claimed or covered subject matter is intended. Among other things, for example, subject matter may be embodied as methods, devices, components, or systems. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that inventive subject matter includes individual or combinations the embodiments in whole or in part, understood as allowing for additional factors not necessarily expressly described depending in part on context. Accordingly, the invention is not to be restricted except in light of the attached claims and their equivalents.

Other apparatus, methods, features and advantages will be, or will become, apparent to one with skill in the art upon examination of the following figures and detailed description. It is intended that all such additional structures, methods, features and advantages are within the scope of the inventions. Nothing in this section should be taken as a limitation on the claims. Further aspects and advantages are discussed below.

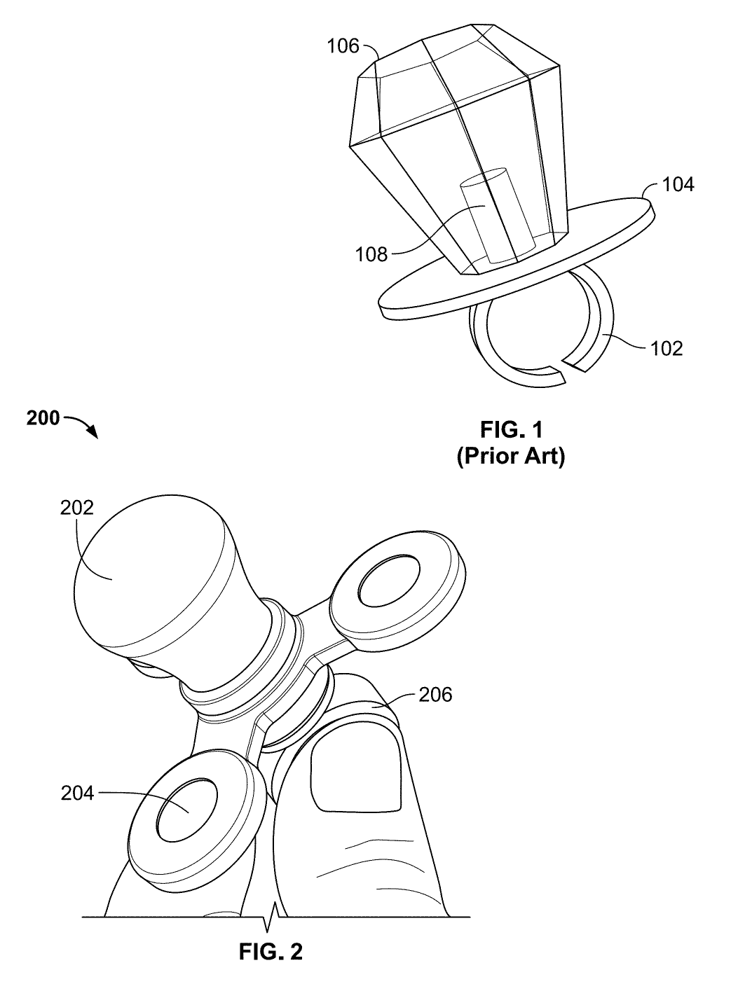

FIG. 1 is a perspective views of novelty hard candy finger ring items known in the prior art. This is one of the most commonly seen candy finger rings on the market, with simple structure. A finger-grasping portion 102 of the prior art ring extends from a plate 104 worn atop a user's hand when the user is wearing the candy finger ring. The plate 104 supports a hard candy 106, with a protruding post extending upwardly from the center of the plate 104, into the inside of the hard candy 106.

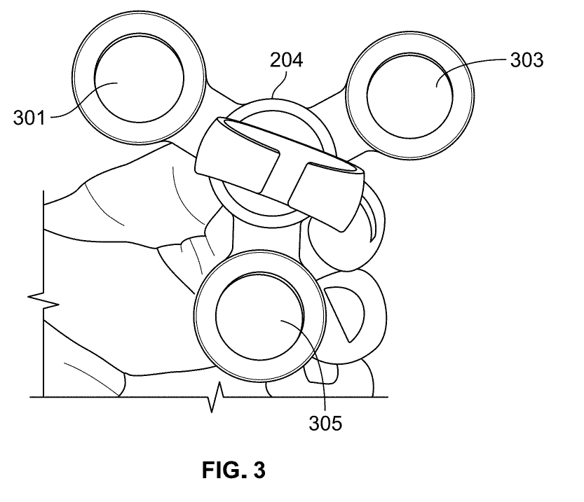

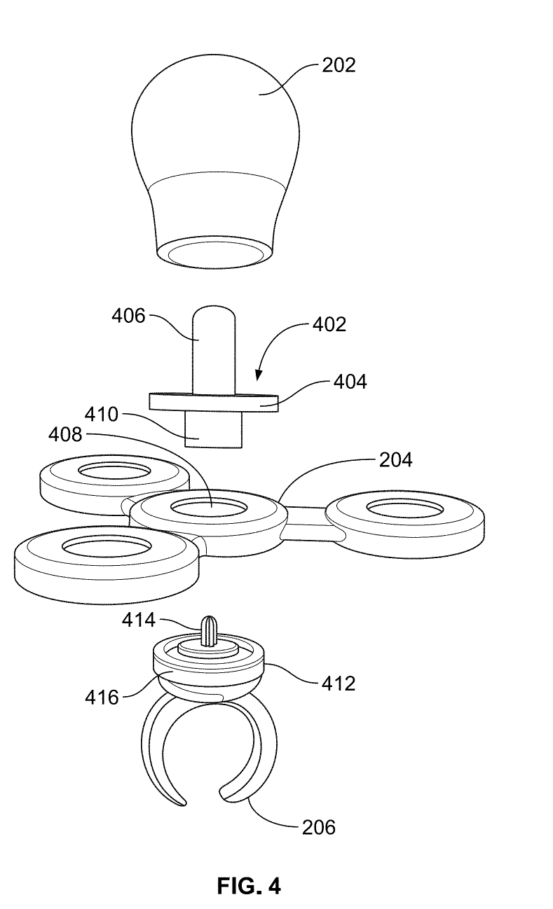

Referring to FIG. 2 illustrates a novelty ring toy 200 according to one embodiment of the present invention combination finger ring, movable spinning object and candy fixed in position by an exterior post 108 or upwardly protruding portion 406 discussed below. The exterior post extends from the finger ring 200 and supports the movable spinning object or spinner 204 at the exterior post between affixed candy and the finger ring 200 discussed herein. The exterior post may include an axle portion supporting the movable spinning object. The ring toy 200 is constructed with methods to be worn as a ring, rather than grasped by the user's hand, and includes an edible portion 202 and a spinner 204 such as a Fidget ™ toy, movable or spinning object with mechanical or visual amusement patterns which may change colors in some embodiments. The edible portion 202 includes hard candy such as a lollipop, sucker candy, or in the alternative gummy candy. The spinner 204 generally represents a non-edible portion of the apparatus which moves or spins freely and can be used even after the top edible portion 202 is consumed. FIG. 2 illustrates the embodiment when the ring is not worn by a user. A finger grasping portion 206 novelty ring housing is also shown in FIGS. 2 and 4 as discussed further below. The spinner 204 movable spinning object may include a circular rotary object propelled into motion by the flick of a finger or by blowing on the movable spinning object which is freely movable and spins relative to the finger ring.

As discussed further below the movable spinning object may include a round disk, the surface of which may include printed colors or patterns on the round disk which may generate a rainbow swirl image or the like, and accordingly while spinning the generated image on the disk creates further amusement for the user while consuming the hard candy. Thus the circular disk for spinning relative to the finger ring may include printed design patterns to generate swirl images using the label adhered to the circular disk with printed designs. Also the exterior post and the axle may be provided as integral with the novelty ring housing of the finger ring. Further once the candy is consumed, the exterior post for holding candy may be inverted such that the exterior post may serve as the tip of a top allowing the round disk to be inverted and used as a top when spun upside down on a surface.

FIG. 3 is a bottom plan view of the novelty ring toy 200. The edible portion 202 illustrated in FIGS. 2A, 2B and 3 is a lollipop or gem form and is provided as a sucker candy pop in the form of a finger ring 200 in the instant invention. The finger-grasping portion 206 in FIGS. 2A, 2B and 3 has an opening 208 to adapt to different sizes of the users finger. The novelty ring housing, the exterior post and the axle molded from plastic together as a single structure. The finger-grasping portion 206 is fabricated from including but not limited to plastic, or other suitable material.

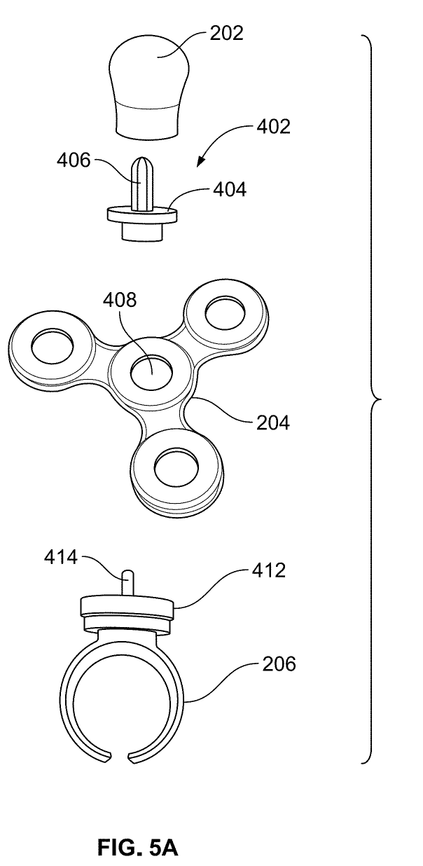

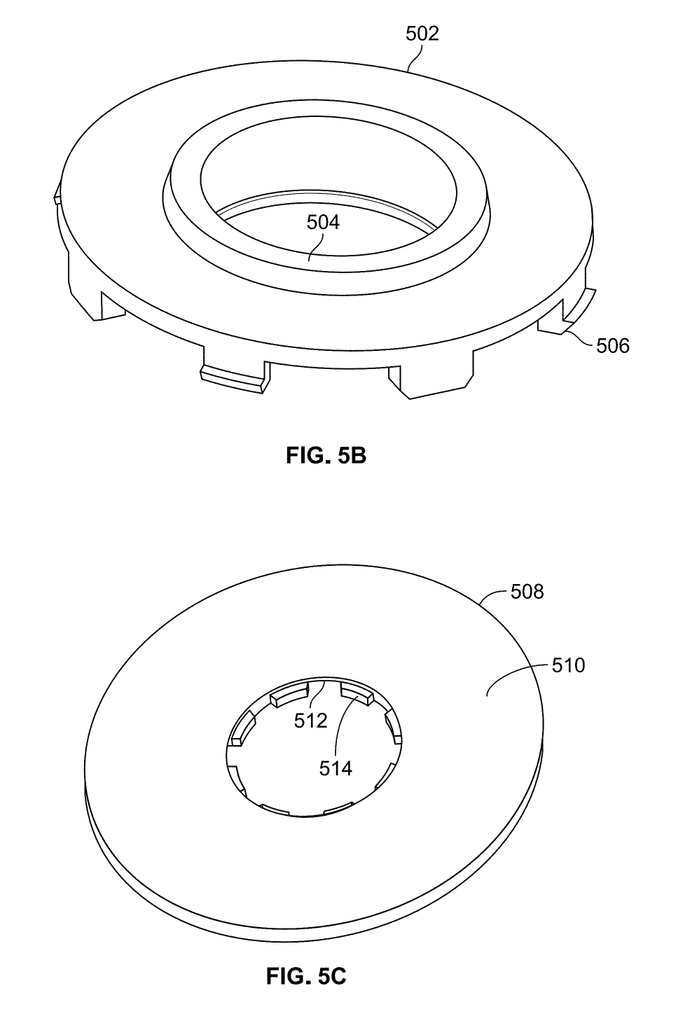

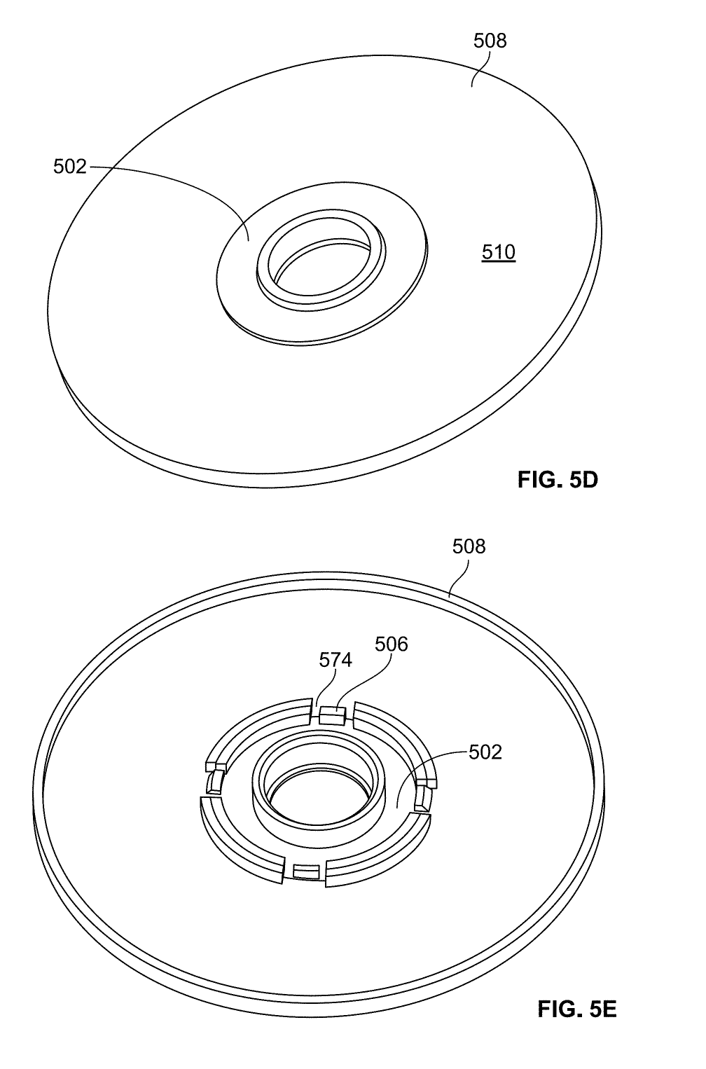

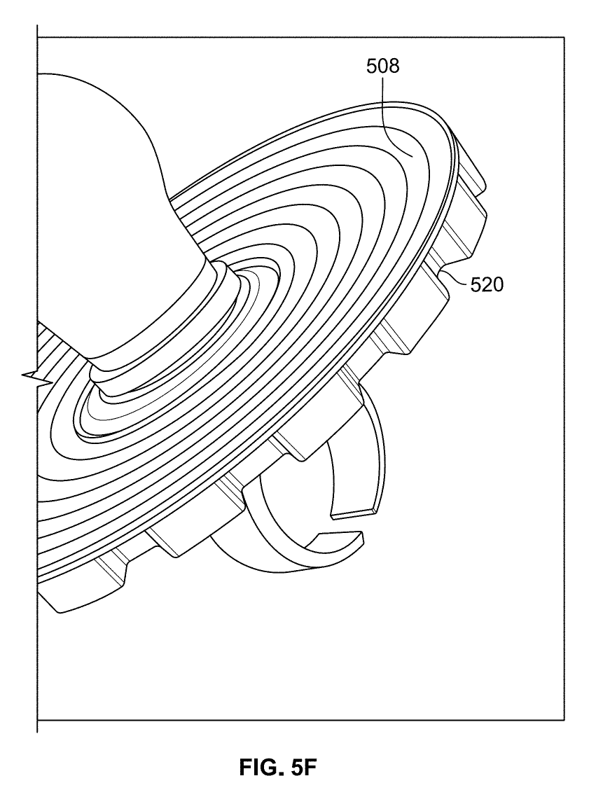

The edible portion 202, as illustrated in FIGS. 2A, 2B and other FIGS. 4, 5A, can be a sucker candy, gummy candy, or any other food product. The bottom view of the ring toy 200 as illustrated in FIG. 3 shows that the spinner 204 has three ends 301, 303, and 305. The three ends 301, 303, and 305 in the spinner 204 is hub-and-spoke shaped in the illustrated embodiment of the present invention. More details of this embodiment will be presented below.

FIGS. 4 and 5A show exploded views of the ring toy 200 in the form of a finger ring combinations of the instant inventions. A base portion 402 supports the edible portion 202. The base portion 402 is formed with a substantially flat platform 404 and an upwardly protruding portion 406. The edible portion 202, usually a candy, has an opening (not shown in this figure) that receives the upwardly protruding portion 406 to hold the candy 202 in place. The upwardly protruding portion 406 is preferably fluted in order to provide a secure grip for the candy 202 during consumption. The upwardly protruding portion 406 in the illustrated embodiment extends from approximately the top center of said substantially flat platform 404.

In FIG. 5A the spinner 204 has a planar body. An orifice 408 is located in the center of the spinner 204 planar body. This center orifice 408 receives a downwardly extending portion 410 that extends from approximately the bottom center of said substantially flat platform 404 of the base portion 402. The downwardly extending portion 410 extends all the way down through the center orifice 408 of the spinner 204, to meet the receiving housing 412 that is attached to the top of the finger-grasping portion 206. The receiving housing 412 comprises a protruding pin 414 to secure the downwardly extending portion 410, and a substantially flat surface to support the spinner 204. The finger-grasping portion 206 itself is not limited to being substantially circular and include the two separate prongs design as shown in the figures, or be formed in a continuous closed loop.

FIGS. 5B through 5E shows component views of an alternate embodiment inner bearings disk 502 and outer disk 508 assembly combination for movable spinning toy amusement objects about respective openings 504 and 512 in accordance with the described embodiments, such that the novelty ring housing incorporates assembly supporting the embodiment inner bearings disk 502 therewith and included as part of novelty ring housing. Accordingly, there is provided a combination finger ring 206, movable spinning object 204, in combination with a hard candy 202 fixed in position by an extended interior post 406 as a candy novelty ring. The downwardly extending portion 410 serves as an axle that the spinner 204 can be propelled into motion by the flick of a finger or by blowing on the spinner 204, with protruding pin 414 extending with support structure 416 to couple and support the bottom of spinner 204.

FIGS. 5B-5E make use of disk 502 and disk 508 assembly with undercut interlocking tab extensions 506 and 514 such that both disk 502 (FIG. 5B) and disk 508 (FIG. 5C) snap together (top side pieces snapped together in FIG. 5D). Manufacturing may be better performed providing the inner bearings disk 502 support structure with an outer diameter of approximately an inch or 2.5 centimeters, and likewise with the outer disk 508 having a center hole inner aperture diameter of approximately an inch. The outer disk 504 may have a larger outer diameter of approximately 1¾ inch or 4.5 centimeters (FIG. 5E showing bottom side pieces snapped together), and thus sufficient for candy 202 to pass through, and snap together. The inner bearings disk 502 may further replace support structure 416 is put onto the shaft and then the shaft is dipped into the lollipop mold. After cooling the outer disk 508 with its sticker or patterned label is placed over the candy 202 and snapped together with inner bearings disk 502. The diameter of the candy 202 is less an inch while inner bearings disk 502 is approximately an inch, thusly the two disks 502 and 508 interlock with a one way snap together (larger disk with label with interlocking fingers for snap fit with inner small disk). Thus conventional candy molds may be properly employed having the approximate one inch inner diameter discussed herein. Likewise a three end hub-and-spoke shaped rotary object, Fidget™ or the like is generally too wide for use with many candy molds. Again the inner bearings disk 502 may be used in conjunction with or instead of hub-and-spoke shaped rotary objects, with outer disk 508 instead of its larger outer diameter of approximately 1¾ inch or 4.5 centimeters may be Fidget™ with opening 1100 of FIG. 11 likewise with the 1100 center hole inner aperture diameter of approximately an inch or 2.5 centimeters, and having e.g. three ends and hub-and-spoke shaped portions snap together at center plate aperture 1100 as the movable spinning object comprises a multi-end hub-and-spoke shaped rotary object through a holding structure at 1100 formed with planer body 700. FIG. 5F shows another embodiment of outer disk 508 as illustrated in FIG. 5E. Recesses 520 align around the underside periphery of outer disk 508 to act as fan blades when blown on, and enhance user experience when blowing and spinning the disk. Other embodiment of the outer disk design include ridges, blades, or any other design that enhance user experience when the user blows or spins the disc 508.

FIG. 6 is a partial view thereof for the ring toy 200 in the form of a finger ring with hard candy 202 removed for illustrative purposes. In the present embodiment the ring part 206 is not intended to be removed from the candy base 402 after being assembled in production, nor removable after consumer use in its present form. The ring 206, base 402 and post 406 combination are assembled into a single piece.

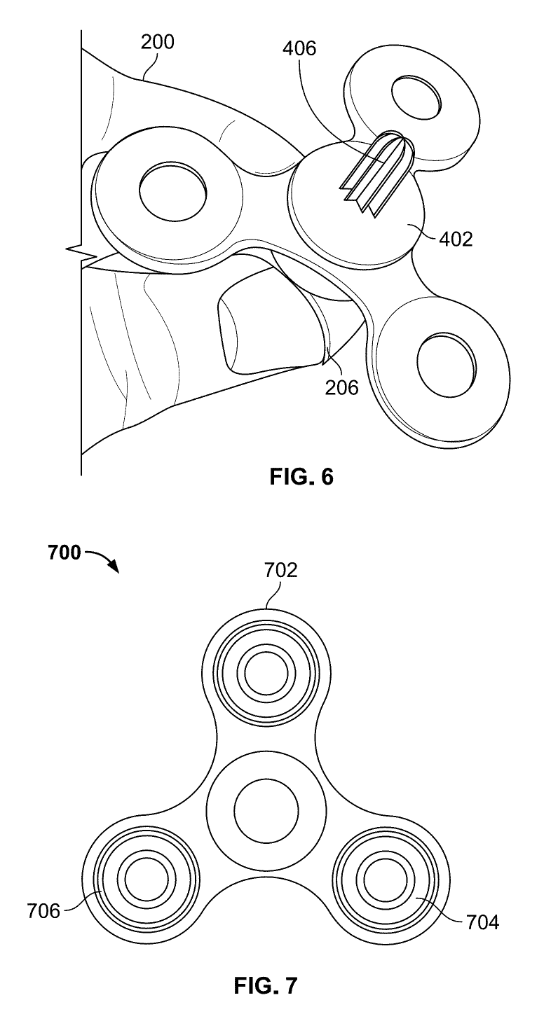

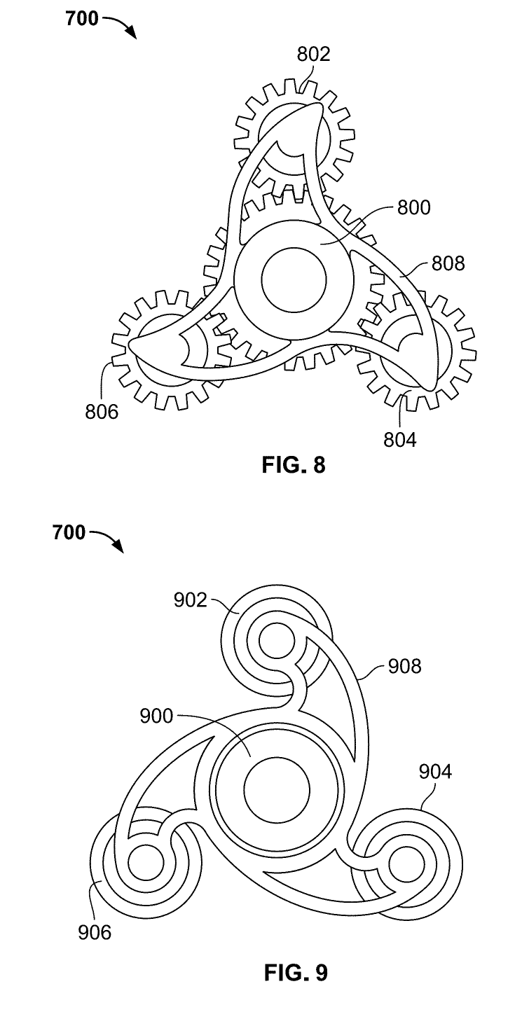

There may be provided several different shapes for the spinning part, for example FIGS. 7, 8, 9, 10 and 11 illustrate exemplary various different embodiments for the spinning portion of the instant inventions which may be used with the finger ring as disclosed. The illustrated examples of the spinning portion of the instant invention all have a planer body 700. The embodiment illustrated in FIG. 7 shows the planer body 700 has three ends 702, 704, and 706, and is hub-and-spoke shaped. The embodiment illustrated in FIG. 8 shows the planer body 700 has three ends 802, 804, and 806. The three ends in this illustrated embodiment are in the shape of three identical gears in a smaller diameter comparing to the center gear 800. The three small gears 802, 804, and 806 are directly in connect with the center gear 800. There is also a holding structure 808 holds the three small gears 802, 804, and 806 are together with the center gear 800 forming the planer body 700 in FIG. 8.

The embodiment illustrated in FIG. 9 shows the planer body 700 has three ends 902, 904, and 906. The three ends in this illustrated embodiment are in the shape of three identical round plate, in a smaller diameter comparing to the center round plate 900. The three small plates 902, 904, and 906 are not directly connected to the center plate 900. The three small plates are hold together with the center plate 900 through a holding structure 908, forming the planer body 700 in FIG. 9.

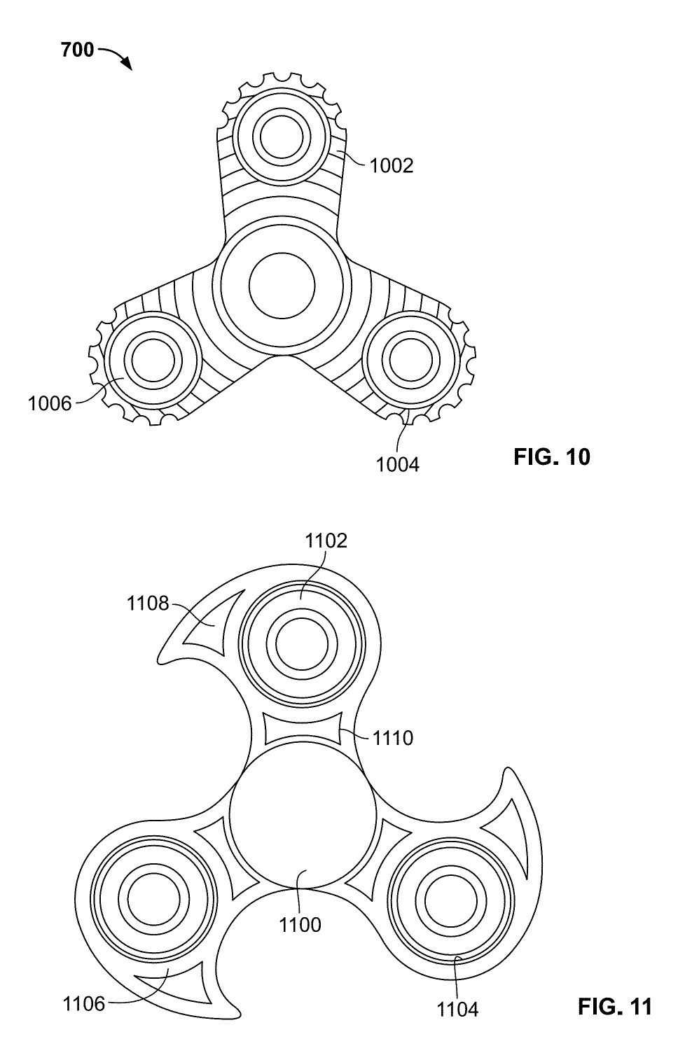

The embodiment illustrated in FIG. 10 shows a similar hub-and-spoke shaped planer body 700 as illustrated in FIG. 7. The three ends 1002, 1004, and 1006 of the planer body in FIG. 10 has gear tooth on their outer edge.

The embodiment illustrated in FIG. 11 shows the planer body 700 has three ends 1102, 1104, and 1106. The three ends in this illustrated embodiment are in the shape of three identical round plate with a beak shaped extension 1108. The three small plates 1102, 1104, and 1106 are not directly connected to the center plate aperture 1100. The three small plates are hold together with the center plate aperture 1100 through a holding structure 1110, forming the planer body 700 in FIG. 11.

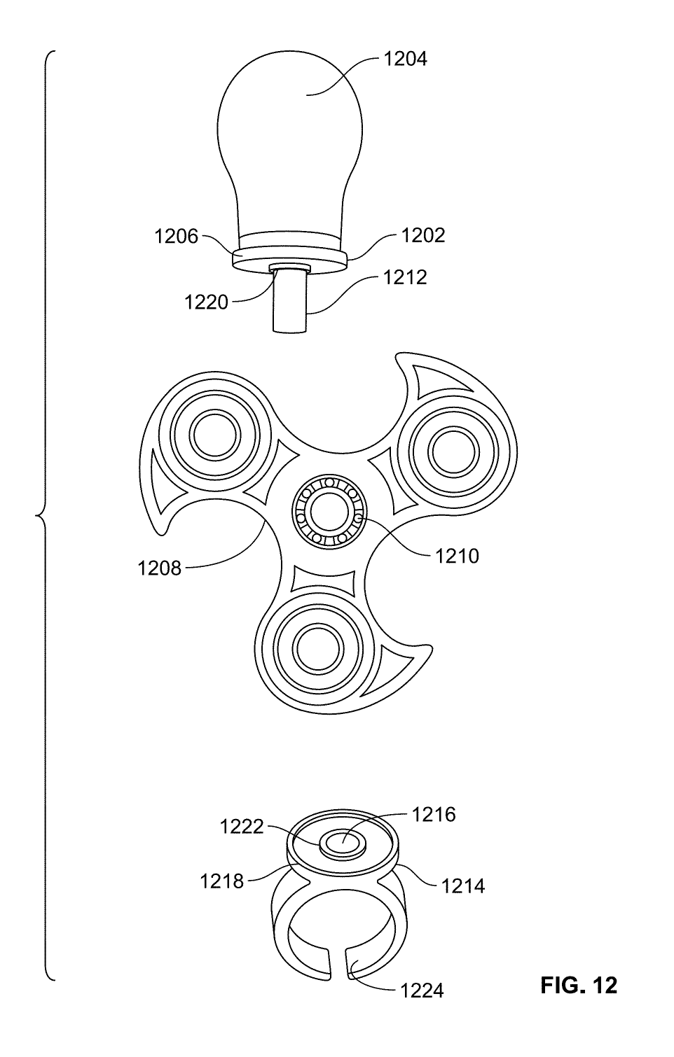

FIG. 12 shows exploded views of yet another embodiment of the toy with hard candy in the form of a finger ring combinations of the instant inventions. A base portion 1202 supports the edible portion 1204. The base portion 1202 is formed with a substantially flat platform 1206 and an upwardly protruding portion (not shown in this figure). The edible portion 1204, usually a candy, has an opening (not shown in this figure) that receives the upwardly protruding portion to hold the candy 1204 in place. The upwardly protruding portion is preferably fluted in order to provide a secure grip for the candy 1204 during consumption. The upwardly protruding portion in the illustrated embodiment extends from approximately the top center of said substantially flat platform 1206.

The spinner 1208 has a planar body. A central mounted ball bearing 1210 is located in the center of the spinner 1208 planar body. This ball bearing 1210 receives a downwardly extending portion 1212 that extends from approximately the bottom center of said substantially flat platform 1206 of the base portion 1202.

The downwardly extending portion 1212 extends all the way down through the center of the ball bearing 1210 of the spinner 1208, to meet the receiving housing 412 that is attached to the top of the finger-grasping portion 206. The receiving housing 1214 comprises an opening 1216 to secure the downwardly extending portion 1206, and a substantially flat surface 1218.

The platform 1206 has a small circle 1220 raising slightly higher from the bottom surface of the platform 1206. The circle 1220 also surrounds the downwardly extending portion 1212. There is another small round circle 1222 raising slightly higher from the substantially flat surface 1218. The two round circles 1220 and 1222 form a clamping device against the inner race of the ball bearing 1210. The downwardly extending portion 1212 serves as an axle that the spinner can be propelled into motion by the flick of a finger or by blowing on the spinner. The receiving housing 1214 is attached on top of the finger-grasping portion 1224. The finger-grasping portion 1224 itself is not limited to being substantially circular and include the two separate prongs design as shown in the figures, or be formed in a continuous closed loop. FIG. 13 illustrates the finger ring toy ready to amuse the user with spinner 1202 which is similar to that illustrated in FIG. 12 and assembled with hard candy and spinner.

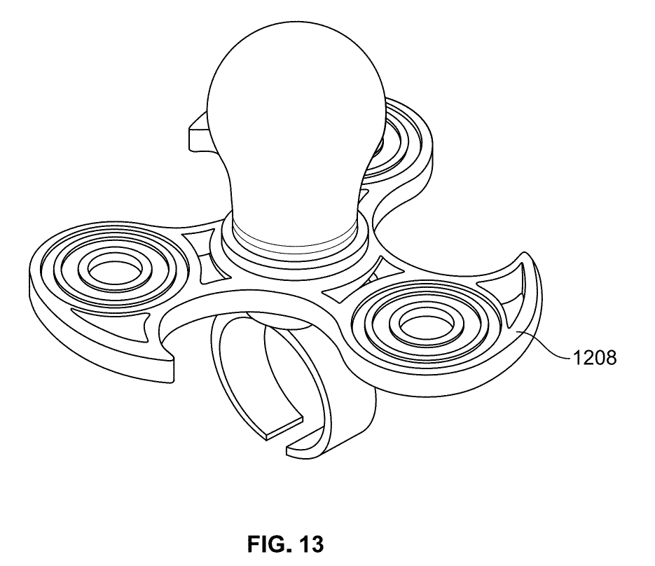

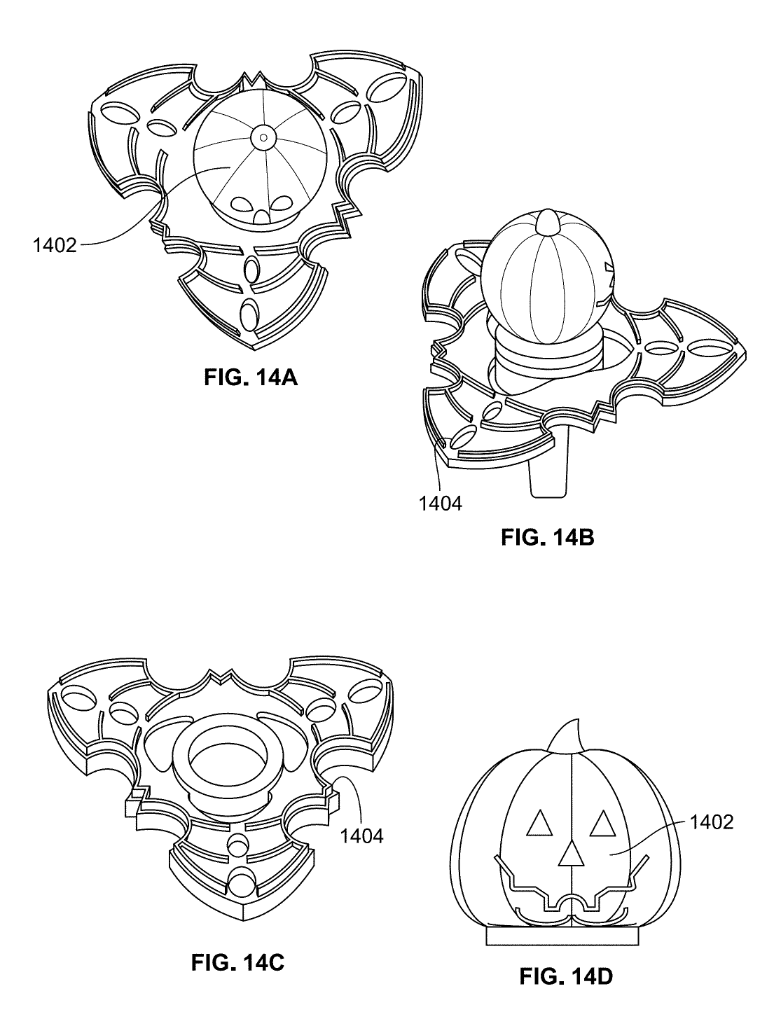

The edible portion of the present inventions can have a wide variety of shapes and colors and flavors. Another example of the edible portion is illustrated in FIGS. 14A through 14D. In FIGS. 14A-14D, the edible portion 1402 is a candy molded the shape of a Halloween themed carved pumpkin which may be embodied in alternate edible and non-edible elements. The upwardly protruding portion in this embodiment also may be provided as molded with a variety of shapes. The disclosed embodiment in FIGS. 14A through 14D has a spinning component 1404 featuring three arrows and three bats as exemplary.

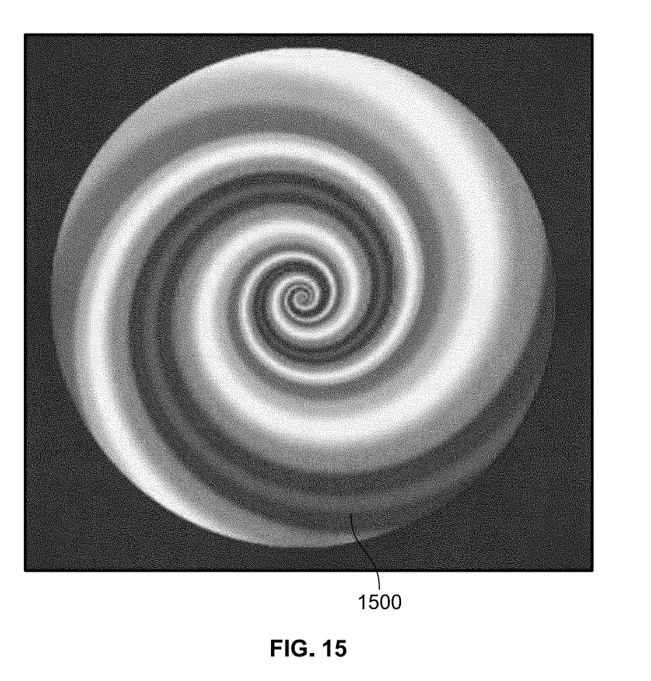

The spinning component of the present inventions can have a wide variety of shapes and colors. Other rotating object such as pinwheels, flowers, propellers can also be used. FIG. 15 illustrates another example of the spinning component. This illustrated embodiment of the spinning component is a round disk 1500. The surface of this round disk 1500 has a rainbow swirl. When spinning, the disk 1500 creates extra amusement for the user, especially when the user plays the spinner while consuming the candy part.

It is to be understood that the embodiments of the invention herein described are merely illustrative of the application of the principles of the invention. From the foregoing, it can be seen that there has been provided a detailed description with various features, and while a particular embodiment of the present invention has been shown and described in detail, it will be obvious to those skilled in the art that changes and modifications may be made without departing from the invention in its broader aspects. Therefore, the aim is to cover all such changes and modifications as fall within the true spirit and scope of the invention. The matters set forth in the foregoing description and accompanying drawings are offered by way of illustrations only and not as limitations. The actual scope of the invention is to be defined by the subsequent claims when viewed in their proper perspective based on the prior art.

What is claimed is:

1. An amusement apparatus comprising:
a finger ring;
an exterior post extending from the finger ring;
an edible portion affixed in position on the exterior post; and
an amusement object including a non-edible portion disposed at the exterior post supporting the object between the affixed edible portion and the finger ring with the object further disposed as moveable in relation to the finger ring and moveable in relation to the exterior post extending therefrom.

2. The apparatus as recited in claim 1 wherein the edible portion is an item selected from the group consisting of lollipop, hard candy, sucker candy, or gummy candy.

3. The apparatus as recited in claim 1 wherein the amusement object is movable for spinning on the exterior post.

4. The apparatus as recited in claim 3 wherein the movable spinning object comprises a multi-end hub-and-spoke shaped rotary object such as a Fidget™ propelled into motion by the flick of a finger.

5. The apparatus as recited in claim 1 wherein the amusement object comprises a circular disk for spinning relative to the finger ring with the circular disk comprising a printed design pattern thereon to generate a swirl image.

6. The apparatus as recited in claim 5 comprising a label adhered to the circular disk comprises a printed design on the label to generate the swirl image.

7. The apparatus as recited in claim 1 wherein the finger ring comprises a novelty ring housing.

8. The apparatus as recited in claim 7 wherein the exterior post comprises an axle portion for supporting the amusement object.

9. The apparatus as recited in claim 8 wherein the exterior post and the axle are provided as integral with the novelty ring housing of the finger ring.

10. The apparatus as recited in claim 9 wherein the novelty ring housing, the exterior post and the axle molded from plastic together as a single structure.

11. An amusement apparatus comprising:
an edible portion;
a finger-grasping portion for engagement with the finger of a user;
a base portion securing and supporting said edible portion;
said base portion having an upwardly extending portion for securing said edible portion;
a spinning portion having a planar body and a center orifice receives a downwardly extending portion of said base portion, and said spinning portion is secured with the base portion and the finger-grasping portion;
a receiving device attached to the top of said finger-grasping portion to receive both said base portion and said spinning portion, and securing said base portion and said spinning portion in place; and
said spinning portion spins freely between said finger-grasping portion and said base portion.

12. The apparatus as recited in claim 11, wherein the planar body of said spinning portion is a singular planar body comprises three ends.

13. The apparatus as recited in claim 11, wherein the planar body is hub-and-spoke shaped.

14. The apparatus as recited in claim 11, wherein the finger-grasping portion has an opening to adapt to different sizes of the users finger.

15. The apparatus as recited in claim 11, wherein the receiving device comprising a protruding pin and a substantially flat surface.

16. The apparatus as recited in claim 15, the planar body of the spinning portion further comprising:
a centrally mounted ball bearing positioned within the center orifice of the planar body, said ball bearing receiving a downwardly extending portion of said base portion with said spinning portion secured with the base portion and the finger-grasping portion; and
a clamping device clamping an inner race of said ball bearing.

17. The apparatus as recited in claim 16, wherein the clamping device comprising a pair of circles raising from said base portion and said receiving device.

18. An amusement method comprising:
providing an edible portion and a non-edible finger-grasping portion;
engaging the finger of a user with said finger-grasping portion;
securing a base portion on said finger-grasping portion;
upwardly extending a support from the base portion for supporting said edible portion on the base portion; and
centrally mounting an amusement object including a non-edible spinning portion with a planar body at a central opening within the planar body received onto the base portion, with the spinning portion moveable atop the base portion and the finger-grasping portion.

19. The method as recited in claim 18, wherein the amusement object is disposed between the edible portion supported on the base portion and the finger-grasping portion securing the base portion, with the planar body of the amusement object comprising a singular body with plural ends in a hub-and-spoke shape.

20. The method as recited in claim 18, wherein the amusement object is moveably disposed in relation to the base portion for spinning relative to finger-grasping portion, with the planar body of the amusement object comprising a circular disk having a printed design pattern thereon to generate a swirl image.
